(19) United States
(12) Patent Application Publication
(10) Pub. No.: US 2001/0014245 A1
(43) Pub. Date: Aug. 16, 2001

(54) PROTECTIVE DEVICE FOR DISPENSING DEVICES

(76) Inventors: CHRIS SERES, MORRISON, CO (US); SHERRILL GARRAMONE, LAKEWOOD, CO (US)

Correspondence Address: GLENN L WEBB, P.O. BOX 951, CONIFER, CO, 80433

(21) Appl. No.: 09/218,308

(22) Filed: Dec. 22, 1998

(51) Int. Cl. B41J 11/62; B41J 29/12

(52) U.S. Cl. 400/693; 400/713

(57) ABSTRACT

A protective device for dispensing devices, such as printers, used in a relatively hostile environment. The protective device includes a dispenser which is mounted adjacent the document feed path opening of the dispensing devices. The dispenser covers the document feed path opening to minimize penetration of grease, oil, moisture or other contaminants into the internal mechanism of the dispensing device. An access opening in the dispenser allows easy retrieval of documents produced from the dispensing device. The top portion of the dispenser acts as a guide for the guiding of the dispensed document through the access opening. The dispenser can be formed as part of a separate enclosure, formed as part of the dispensing device cover assembly or provided as a separate accessory which can be mounted on the dispensing device cover assembly.

### FIELD OF THE INVENTION

This invention relates to the field of protective covers for dispensing devices, and particularly to the field of protective covers for dispensing devices in hostile environments.

### BACKGROUND OF THE INVENTION

Electronic systems are presently in widespread use in many transactional businesses, such as in restaurants. These systems, commonly referred to as point of sale systems, are used to electronically transmit orders from an order taker to a remote location, such as a kitchen, in order to speed service and improve the reliability of the business. The server inputs the order either by a portable input device or fixed input device and a printer in the kitchen prints out the order. The order is then prepared without the need for the server to manually walk the order to the kitchen. The system can also track the order and print a final customer receipt. The printers are typically a thermal, dot matrix or impact printer which prints onto paper rolls to minimize maintenance and replacement of paper and ink supplies to the printer. The printed order is moved along a printer feed path to an upper opening where it is either torn from the roll by hand or by an automatic cutting device.

Many of these dispensing devices, such as printers, ticket dispensers, order dispensers, diagnostic devices and other similar devices, are used in relatively hostile environments. For instance, systems used in commercial kitchens undergo contamination of the printers by grease and oils from the preparation of food. Not only are the printers coated with the grease and oils, but the internal feed path of the printers from which the printed orders are received is frequently contaminated by the grease and oils as well as moisture. The internal workings of the printers thus require frequent cleaning and maintenance from this contamination. The cost of this cleaning and maintenance is not only expensive from the service point of view but also by the downtime during the service itself. The need to clean and service these printers several times a year is not only expensive but takes the printer out of service for several days at a time.

These dispensing devices not only suffer damage in kitchen environments but in other hostile environments, such as in factories, garages, salons and other environments where there may be grease, oil or other environmental contaminants. Also, some dispensing devices may even be used in an outdoor environment exposed to the elements.

One prior attempt to minimize the damage to the dispensing devices from the hostile environment has been a simple “box” which is placed over the dispensing devices. The box has an opening above the upper opening of the paper feed path through which the order is dispensed. However, this prior art device does not solve the problem of the feed path and internal mechanism being contaminated by the environment of the kitchen. Other prior covers were simply used for storage of the printer and do not provide access to the dispensed orders.

None of the previous transactional order systems are capable of providing protection for dispensing devices in a hostile environment. There is a need for such protection.

### SUMMARY OF THE INVENTION

The present invention solves these and other problems by providing a device that protects dispensing devices in a hostile environment while still maintaining easy access to the dispensed documents. The present invention accomplishes this by providing a device and method of protecting the document feed path of dispensing device while providing access to documents provided by the dispensing device. An access opening is provided in the dispenser to allow the dispensed document to be retrieved. The protective device of the present invention includes various preferred embodiments to accomplish the invention.

A preferred embodiment of the present invention provides a protective device formed as a separate enclosure. The enclosure is simply placed over the dispensing device to be protected. This enclosure includes a dispenser which is placed adjacent and over the document feed path opening of the dispensing device. The dispenser includes a top portion, which in one preferred embodiment, is angled upward. The top portion extends over an access opening which is over the document feed path opening of the dispensing device. In use, the enclosure protects the dispensing device and in particular the document feed path opening of the dispensing device from the environmental contaminates, such as grease, oil, moisture and airborne food particles. The documents are dispensed from the dispensing device through the document feed path opening. The dispensed document is guided through the access opening of the enclosure by the angled top portion. The dispensed document is then easily retrieved. In one embodiment, the enclosure is formed from a transparent, durable material which is preferably dishwasher safe.

In another embodiment of the present invention, the top portion of the dispenser of the protective device includes an additional guide. In this embodiment, a groove is formed extending downward from the top portion. This groove further guides the dispensed document through the access opening of the protective device.

Other embodiments of the present invention include a flat top portion of the protective device dispenser. This embodiment is useful in dispensing devices which automatically cut the dispensed document. The document is simply retrieved through the access opening. Other embodiments of the protective device dispenser are also contemplated depending on the operation of the dispensing device which is to be protected.

Another embodiment of the present invention is also considered. In this embodiment, the dispenser is formed as part of the dispensing device cover assembly. Thus no separate enclosure is necessary. Also, in another embodiment, the dispenser is provided as an accessory item which can be attached onto the dispensing device adjacent the document feed path opening by adhesives, screws, Velcro™ or other fastening mechanisms.

These and other features of the present invention are readily evident from the ensuing detailed description of a preferred embodiment in conjunction with the drawings.

### BRIEF DESCRIPTION OF THE DRAWINGS

FIG. 1 is a perspective view of a preferred embodiment of the present invention;

FIG. 2 is a side view of the embodiment of FIG. 1;

FIG. 3 is a rear view of the embodiment of FIG. 1;

FIG. 4 is a perspective view of the embodiment of FIG. 1 in use;

FIG. 5 is a perspective view of a typical dispensing device on which the present invention is to be used;

FIG. 6 is an alternative embodiment of the present invention;

FIG. 7 is another alternative embodiment of the present invention; and

FIG. 8 is another alternative embodiment of the present invention.

### DETAILED DESCRIPTION OF A PREFERRED EMBODIMENT

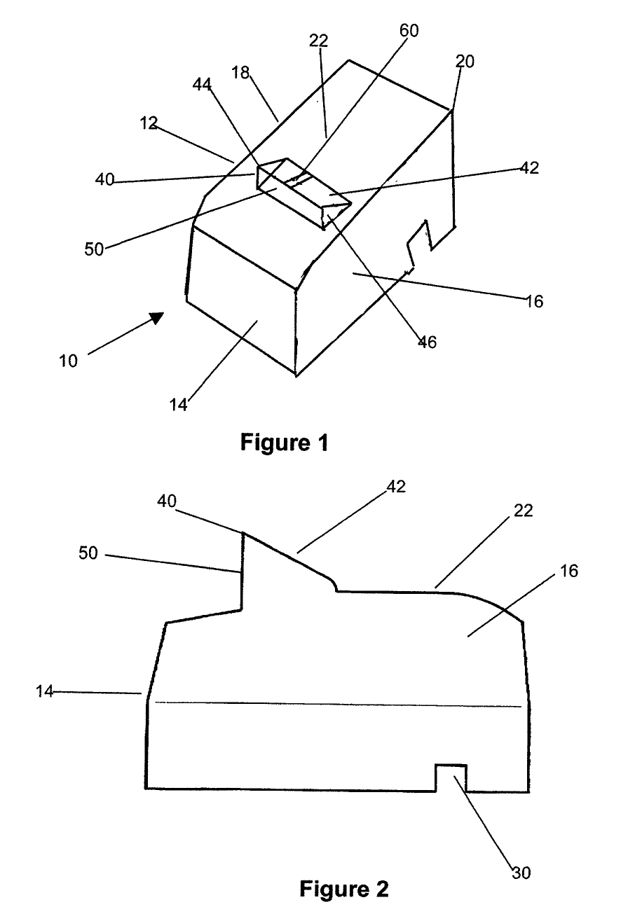

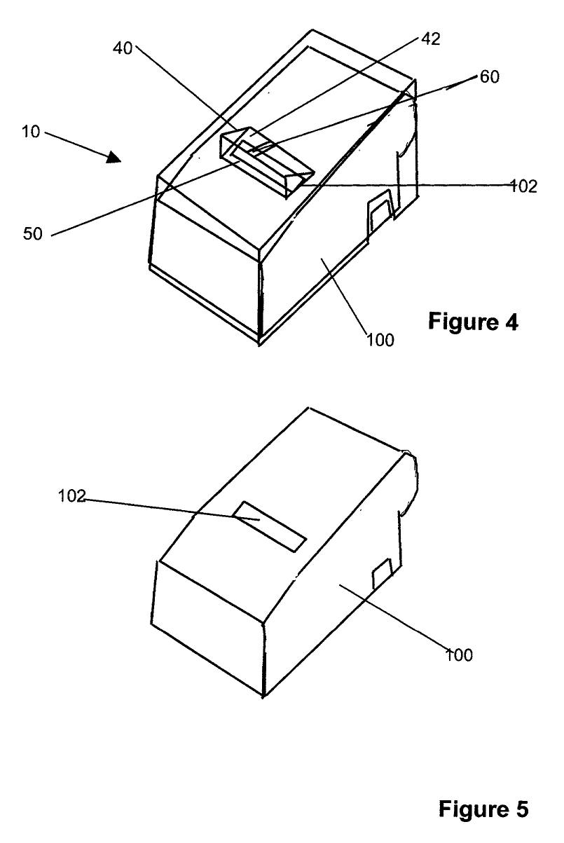

The present invention provides a protective device for dispensing devices in hostile environments and also provides ready access to the output from the dispensing device. A preferred embodiment of the present invention is illustrated in FIGS. 1-4. It is to be expressly understood that this descriptive embodiment is provided for explanatory purposes only and is not meant to limit the scope of the claimed inventive concept. Other embodiments and variations are considered to be within the scope of the present invention.

It is also to be expressly understood that the dispensing devices referred to in this descriptive embodiment and in the claims appended thereto includes any type of dispensing device from which an output is produced, including but not limited to printers, ticket dispensers, order dispensers, receipt dispensers, and the like. Also, the terms document or order, as discussed herein, are not to be limited but include printed orders, receipts, tickets, diagnostic information, information on a tangible medium, and any other type of document.

The protective device 10 of the preferred embodiment is shown in FIG. 1. The protective device 10 includes an integral body 12 formed from transparent molded plastic material. It is to be expressly understood that other construction techniques and materials can be used as well, such as opaque plastic, wood, metal or other structural materials. In the preferred embodiment, the use of a lightweight transparent plastic that is substantially dishwasher safe and/or is easily cleaned is preferred. The use of the transparent material enables the operation of the dispensing device, as described below, to be monitored. Also, the ability of the material to be cleaned in a dishwasher or otherwise, as described below, adds to the functionality of the device.

The body 12 of the protective device 10 includes a front panel 14, side panels 16, 18, rear panel 20 and top panel 22. Each of the panels 14-22 are contoured to fit over the dispensing device 100, described in greater detail below. It is to be understood that the contour of the panels 14-22 is not required within the scope of the claimed invention but adds further aesthetic appeal as well as minimizing the size of the protective device 10. Also, it limits the ability of debris, such as grease and oil, from collecting on the outside of the printer. Other shapes and configurations are expressly understood to be within the scope of the claimed invention.

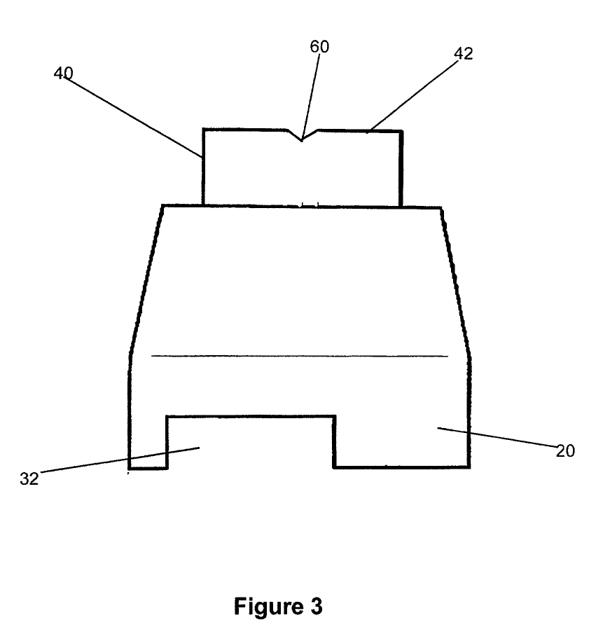

Slot 30, as shown in FIG. 2, is formed in the lower portion of side panel 16. The slot 30 allows access to the power switch of the dispensing device. Thus the protective device 10 does not need to be removed to allow operation of the dispensing device. Slot 32 is formed in the rear panel 20 of the body 12 of the protective device 10 as shown in FIG. 3. The slot 32 provides access for the power cord and cable of the system. Other slots or holes may be added as desired.

A key feature of the present invention is the dispenser 40, as shown in FIGS. 1-4. The dispenser 40 is formed in the top panel 22 of the body 12 of the protective device 10. The dispenser 40 includes a top portion 42, and side portions 44, 46. An access opening 50 is formed in the dispenser 40 to be over the document feed path opening of the device from which the document will be produced. In the preferred embodiment of the present invention illustrated in FIGS. 1-4, the access opening 50 of the dispenser 40 opens in the direction of the rear panel 22. The top portion 42 of the dispenser angles upward from the top panel 22 to provide a guide for the document from the dispensing device. The document is guided by the top portion 42 to be dispensed through access opening 50.

In the preferred embodiment shown in FIGS. 1-4, the dispenser 40 further includes a substantially “v” shaped groove 60 in the center of the top portion 42, shown in FIG. 3, and extends downward towards the dispenser opening. This groove 60 provides an additional guide for the dispensed document. This additional guide is particularly useful for devices that do not automatically cut the dispensed document. The paper or other media on which the document is produced is often provided in a roll and retains a tendency to remain curved. This tendency causes the produced document to curve away from the access opening 50. The angled top portion 42 along with the groove 60 overcomes this tendency and guides the dispensed document through the access opening 50 where the document can be manually torn from the paper roll. It is to be expressly understood that other guide configurations other than the “v” groove could be utilized as well.

### Operation

A typical printer used in point of sale transactions is illustrated in FIG. 5. It is to be expressly understood that this printer is only described for explanatory purposes and other types of dispensing devices are included within the claimed invention. This printer 100, such as the Epson TM-300 printer manufactured by the Seiko Epson Corporation, includes a document feed path opening 102 from which a printed document is dispensed. In normal operations in a restaurant kitchen, grease, oil and other environmental contaminants penetrate into the dispenser opening 102 and contaminate the internal mechanism of the printer 100. The contaminates will also collect on the exterior of the printer as well.

The protective device 10, as shown in FIG. 5, protects the printer, and in particular, the document feed path opening 102. The top portion 42, side portions 44, 46 and rear portion 48 of the dispenser 40 minimize the penetration of contaminates into the document feed path opening 102 of the printer 100. The printed document 106 is dispensed from the printer 100 and guided through the access opening 50 of the dispenser 40 by the groove 60. The front panel 14, side panels 16, 18, rear panel 20 and top panel 22 also provide protection from contamination by the grease, oil, moisture and other contaminants.

The protective device 10 can easily be cleaned by placing in a dishwasher or by simply washing by hand. This device is extremely durable and can be cleaned repeatedly. This is an important quality for restaurant use where health inspections are required.

### Alternative Embodiments

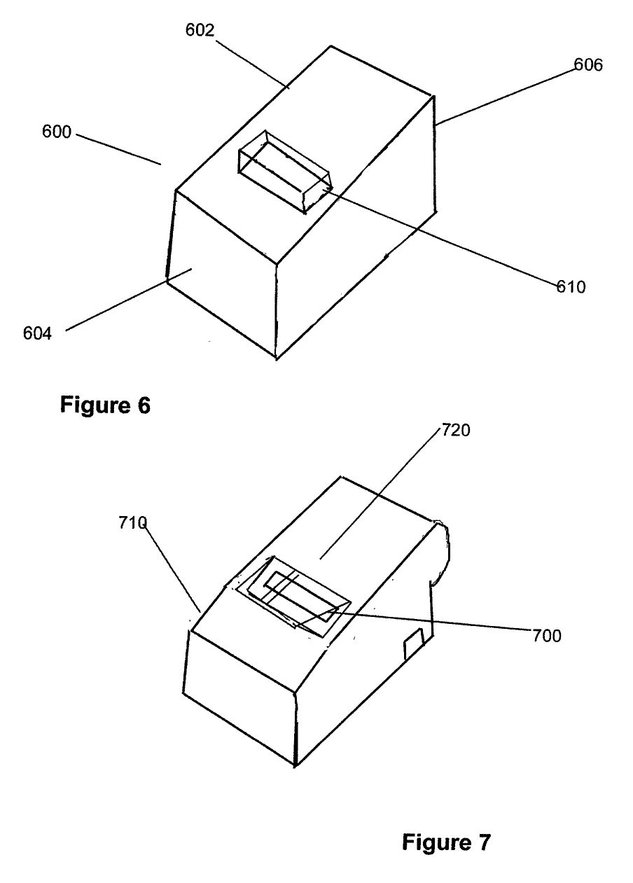

Other preferred embodiments of the protective device of the present invention are contemplated as well. For instance, and without limiting the scope of the claimed inventions, the protective device 600 shown in FIG. 6 includes a body 602 similar to the above described embodiment. However, the dispenser 610 faces towards the front panel 604 instead of the rear panel 606. Also, the dispenser 610 does not use a guide groove. This particular embodiment is useful for dispensing devices which include an automatic cutting mechanism for the dispensed document when the produced document is dispensed from the dispensing device. The cut document does not possess the tendency to curve to the extent that the non-cut document does. The cut document merely drops in place where it can be easily retrieved.

Other configurations of the dispenser can be used, depending in large degree on the type and configuration of the dispensing device on which it is to be used. A key feature with these embodiments is to protect the document feed path opening of the dispensing device while allowing ease of access to the dispensed document.

Another alternative embodiment of the present invention is shown in FIG. 7. The dispenser 700, similar to the dispenser 60 shown in FIGS. 1-4, is integrated directly into the cover 720 of the dispensing device 710. This eliminates the need for a separate protective device while still providing the protection from contamination of the internal mechanism of the dispensing device. Other styles of the dispenser can also be integrated in various other dispensing devices as well.

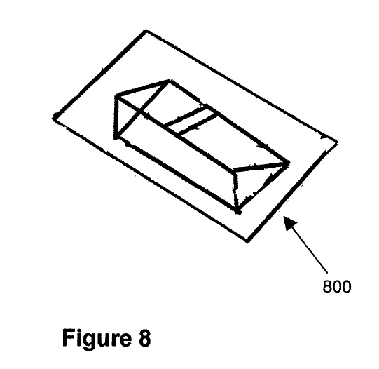

In another embodiment of the present invention, shown in FIG. 8, the dispenser 800 of the protective device is provided as an accessory item. The dispenser 800 is attached onto a dispensing device adjacent the document feed path opening by adhesives, by screws, by a hook and loop attachment such as Velcro™ or other types of fastening mechanisms. This enables the dispenser to be used on any number of existing devices without the need for the enclosure.

Other embodiments of the present invention are also considered to be within the scope of the claimed inventions. For example, a flexible or hinged shutter could be affixed to the dispenser across the access opening. The shutter would flex or pivot outward as the document is dispensed. This provides additional protection from the environmental contamination.

These descriptive embodiments are intended for explanatory purposes only. The present invention, as claimed, includes other implementations and embodiments as well.

What is claimed is:

1. A protective device for dispensing devices, said protective device comprising:
means for covering at least the document feed path opening of the dispensing device; and
means for providing access to the document received from the dispensing device.

2. The protective device of claim 1 wherein said means for covering at least the document feed path opening of the dispensing device includes:
a separate enclosure for mounting over the dispensing device.

3. The protective device of claim 1 wherein said protective device further includes:
said protective device is an integral part of the dispensing device.

4. The protective device of claim 1 wherein said protective device further includes:
said protective device is secured to a portion of the cover assembly of a dispensing device.

5. The protective device of claim 1 wherein said means for covering at least the document feed path opening of the dispensing device includes:
means for guiding the document produced from the dispensing device into said means for providing access.

6. The protective device of claim 5 wherein said means for guiding the dispensed document includes:
an angled top portion.

7. The protective device of claim 5 wherein said means for guiding the dispensed document includes:
a top portion; and
a groove extending towards the document feed path opening of the dispensing device to guide the produced document.

8. The protective device of claim 1 wherein said protective device includes:
at least a portion of said protective device is formed from a transparent material.

9. The protective device of claim 1 wherein said protective device includes:
said protective device is formed from a material that is substantially dishwasher safe.

10. The protective device of claim 1 wherein the dispensing device includes:
a printer.

11. A protective device for protecting a dispensing device from environmental contamination, said protective device comprising:
a dispenser;
means for securing said dispenser adjacent the document feed path opening of a dispensing device to cover the document fee path opening; and
an access opening in said dispenser and extending adjacent the document feed path opening of the dispensing device.

12. The protective device of claim 11 wherein said means for securing said dispenser includes:
means for securing said protective device to the dispensing device cover assembly adjacent the document feed path opening of the dispensing device.

13. The protective device of claim 11 wherein said means for securing said dispenser includes:
said protective device is an integral portion of the cover assembly of the dispensing device.

14. The protective device of claim 11 wherein said means for securing said dispenser includes:
a separate enclosure which mounts over the dispensing device.

15. The protective device of claim 11 wherein said dispenser includes:
means for guiding a document from the document feed path opening of the dispensing device through said access opening.

16. The protective device of claim 15 wherein said means for guiding a dispensed document includes:
an angled top panel on said dispenser.

17. The protective device of claim 15 wherein said means for guiding a dispensed document includes:
at least one groove extending downward in a top panel on said dispenser.

18. The protective device of claim 11 wherein said protective device further includes:
at least a portion of said protective device being transparent.

19. The protective device of claim 11 wherein said protective device further includes:
said protective device being formed from a dishwasher safe material.

20. The protective device of claim 11 wherein the dispensing device includes:
a printer.
